(19) United States
(12) Patent Application Publication
(10) Pub. No.: US 2014/0054962 A1
(43) Pub. Date: Feb. 27, 2014

(54) Electric Energy Deployment Model for Solar System

(71) Applicant: LT LIGHTING (TAIWAN) CORP., Xiangshan Dist. (TW)

(72) Inventors: Geoffrey Wen-Tai Shuy, Taipei City (TW); Jau-Dar Liao, Toufen Township (TW); Chang-Horang Li, Hsinchu City (TW)

(21) Appl. No.: 13/910,964

(22) Filed: Jun. 5, 2013

Related U.S. Application Data
(63) Continuation of application No. 13/592,221, filed on Aug. 22, 2012, now abandoned.

(51) Int. Cl. H02J 1/00

(52) U.S. Cl. CPC H02J 1/00
USPC 307/23; 307/31

(57) ABSTRACT

An isolated mid-sized centralized photovoltaic solar station that includes a solar panel subsystem that converts photon energy into electricity, and a battery subsystem an energy reservoir to store electrical energy generated by the solar panel subsystem. A control unit regulates the output of energy from the solar panel system onto a low voltage electrical system that provides electrical power to electricity consuming devices or systems. The electrical system may operate at less than 50 volts thereby make the protection system less expensive. Furthermore, some of the batteries in the station may be mobile, so that they can be transported and used external to the station.

### CROSS-REFERENCE TO RELATED APPLICATIONS

The present application is a continuation-in-part of U.S. patent application Ser. No. 13/592,221 filed Aug. 22, 2012, which is incorporated herein by reference in entirety.

### BACKGROUND

Photovoltaics involve directly converting light energy from incident photons into electricity. Photovoltaic systems for electric power generation are in commercial use (referred as “solar electric systems” herein). The solar electric systems receive energy from the sun-light at photovoltaic solar panels, whereupon the panels directly convert the photons into electricity.

There are generally two categories of photovoltaic energy deployment in common practice today. In a first category, the photovoltaic system is used as a power source supplying electricity to the power grid. In order to connect to the power grid, adjustments are required such as, for example, Direct Current (DC) to Alternating Current (AC) conversion, voltage regulation, and phase regulation. In a second category of photovoltaic energy deployment, the photovoltaic system is used as stand-alone system, being isolated from power grids. In other words, the electricity deployment from the photovoltaic systems can be categorized into (1) photovoltaic systems that connect to the power grid at least some of the time (herein also referred to as a “centralized” system or “power grid” system), or (2) photovoltaic systems that do not connect to the power grid at all (herein also referred to as an “isolated” system, or as a “stand-alone” system).

Usually, the power grid systems are built to be quite large in size and power delivery capacity to capture the size-benefits, much as what centralized systems would do. For instance, a typical centralized system is often greater than 200 Megawatts. On the other hand, isolated systems (such as the solar street lamps) are usually small in size and power delivery capacity to increase their affordability, and perhaps because restricted by smaller local energy demand. Due to their smaller size, the isolated systems usually lose the size-benefit-effects that are present in centralized systems.

However, the providing and maintaining of the centralized system requires payment for equipment for necessary power-conditioning and power-management (including the DC to AC conversion; and voltage and AC phase regulations), providing an expensive protection system to protect valuables (including human lives) from the giant grid-power, and the power grid construction and maintenance. On the other hand, the isolated systems can save most of these costs. Therefore, both photovoltaic system deployment categories can find suitable practical applications in different situations.

### BRIEF SUMMARY

Embodiments described herein support a new way of deployment for solar electric energy; aiming at an isolated mid-size power (5 kilowatt to 500 kilowatt) stationary station to capture the opportunity of having size-benefits, while not to inherit most of the cost burdens associated with a centralized photovoltaic solar system. This system is referred as an “isolated centralized solar electric system” herein. At least some of the described embodiments are suitable for solar electric energy deployment in rural areas and many locations in the world where there is plenty of sun-light, spotty housing distribution with very low population density, and/or where there is no expensive power grid due to the expense of the power grid. When coupling with effective lighting elements, it is especially suitable for lightings in these areas.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 abstractly illustrates an isolated centralized solar power system in accordance with embodiments described herein; and

FIG. 2 illustrates a flowchart of a method for using an isolated centralized photovoltaic solar station.

### DETAILED DESCRIPTION

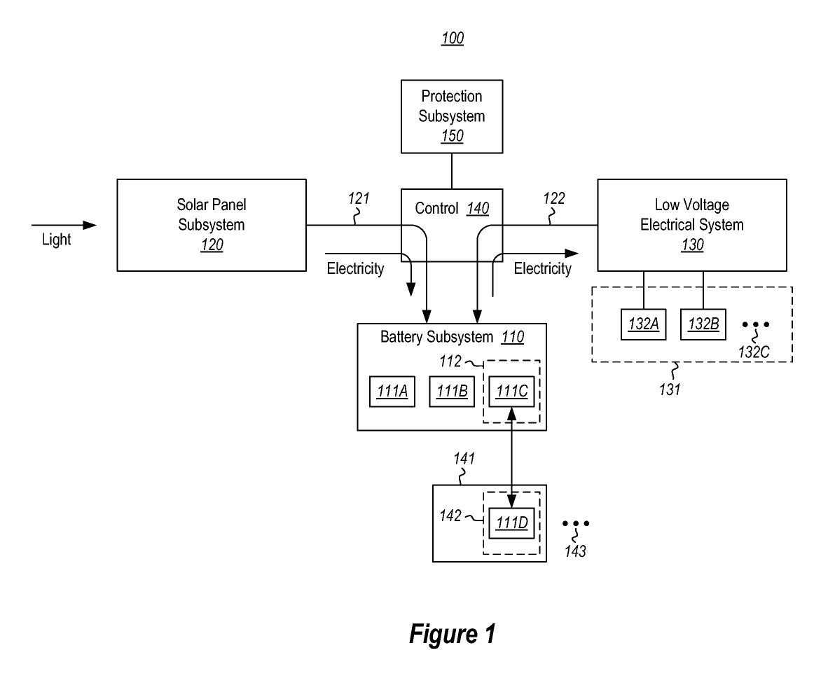

In accordance with at least one embodiment described herein, an isolated centralized solar electric system (also referred to as the “isolated station” herein) is described. An example embodiment of the isolated station is illustrated in FIG. 1 as element 100. The isolated station is stationary and mid-sized. In this context, a “mid-sized” power station is a stationary power station capable of generating power somewhere in the range of from 5 kilowatts to 500 kilowatts. The isolated station is not connected to a large-scale power grid that spans portions of nations, and even internationally. Instead, the isolated station is coupled to a smaller local power grid.

Thus, while the mid-sized isolated station is similar to a centralized station in that it is stationary, the mid-sized power station is much different than the centralized station in that the isolated station is orders of magnitude smaller and is coupled only to a local power grid.

The isolated centralized solar system 100 consists four subsystems: (1) the solar panel subsystem 120 comprising one or more solar panel elements that directly convert photon energy into electricity; (2) a control unit 140 comprising switches, circuitries, data acquisitions and logic decision making modules that regulates the operation in the station; (3) the protection subsystem 150 comprising the detection circuits, logic circuits, and switches to protect the valuables in the station including solar panels, batteries, and lives; and (4) battery systems 110 comprising banks of batteries. So that redundancy can be greatly reduced, the control unit 140 may be combined with the protection subsystem 150 when appropriate.

As in most isolated solar power systems, the isolated centralized solar electric energy system converts the light photons into electricity by a power generating system comprising solar panels; and also uses a battery system as an energy reservoir to store electrical energy such that the energy can be used as needed regardless of whether sunlight is then present.

The station may use relatively low-voltage (say, below 50 volts) with mid-scale power size. In this case, a necessary control/protection unit may 140/150 be equipped to manage the solar panels; to regulate both the incoming of electrical energy (as represented by arrow 121 in FIG. 1) and the outgoing of the energy onto the low voltage electrical system 130 (as represented by arrow 122 in FIG. 1) such that the electrical voltage is properly conditioned (e.g., at perhaps volts or lower if a very low voltage system. The protection unit 150 protects the valuables (including the solar panels and batteries) from the low voltage electrical system 130.

The low voltage electrical system 130 is connected to multiple electricity consuming devices or systems 131. In particular, the electrical system 130 is illustrated as including device/system 132A and device/system 132B, although the ellipses 132C represents flexibility in the number fo power consumer devices or systems connected to the electrical system 130. However, because the whole electrical system 130 is much small in power size comparing to the power grid, and also because it is designed to function in low-voltage DC form; it poses no threat to lives (human and animals). Thus, the protection subsystem 150 costs much less than the protection subsystem used in the conventional centralized solar systems that connect to the power grid.

The electric energy generated at the station shall be stored in the battery subsystem 110 that acts as energy reservoir. The battery subsystem 110 stores electrical energy generated by the solar panel subsystem 121 such that the electrical energy may be used as needed regardless of whether sunlight is then present.

The battery subsystem 110 contains multiple battery systems. These battery systems are categorized into (a) station batteries 111A and 111B that stay in the station most of the time; and (b) mobile batteries 111C and 111D that are intended to be transported from the station to customers' locations, households or others locations, so that such mobile batteries may be used as mobile carrying electrical energy. For instance, mobile battery 111D, having been previously charged within port 112 (i.e., a location at which a mobile battery may be plugged into the battery subsystem 110), has been removed from port 112, transported to a customer location, and plugged into port 142 of an electricity consuming device/system 141. The ellipses 143 represents that this transport may be performed for any of multiple electricity consuming devices/systems.

Thus, the solar-electric energy generated in such a station may also be deployed by using the mobile batteries as energy containers to physical transport the electrical energy to the customers. If the customers have any energy-depleted batteries, they may be returned to the station in order to re-energize the mobile matters. The returned mobile batteries will be recharged up by banks of station batteries. For instance, battery 111C is shown plugged into port 112.

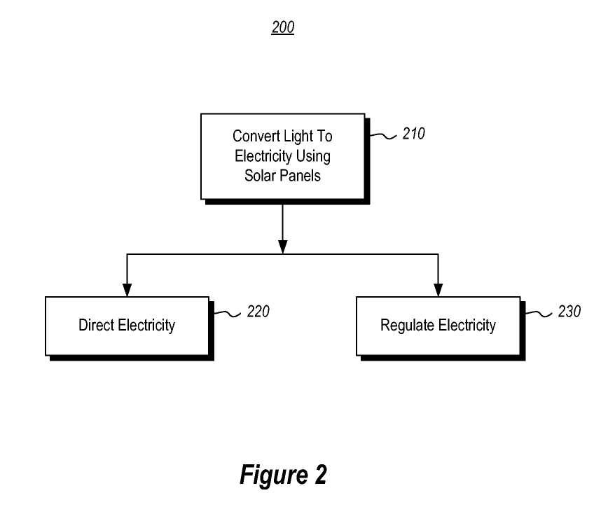

FIG. 2 illustrates a flowchart of a method 200 for using an isolated centralized photovoltaic solar station. The method 200 may be performed by, for example, the isolated centralized station 100 of FIG. 1. The method 200 includes using a solar panel subsystem (e.g., 120) comprising one or more solar panel elements to directly convert photon energy into electricity (act 210), a control unit (e.g., 140) determining whether to store the electrical energy generated by the solar panel system in a battery subsystem or provide the energy generated by the solar panel system onto a low voltage electrical system that provides electrical power to a plurality of electricity consuming devices or systems (act 220), and an act of the control unit further regulating electrical energy provided to the lower voltage electrical system (e.g., 130) (act 230).

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An isolated mid-sized centralized photovoltaic solar station comprising:
a solar panel subsystem comprising one or more solar panel elements that are configured to directly convert photon energy into electricity;
a battery subsystem comprising a plurality of batteries that are configured as an energy reservoir to store electrical energy generated by the solar panel subsystem such that the electrical energy may be used as needed regardless of whether sunlight is then present; and
a control unit configured to regulate the output of energy from the solar panel subsystem onto a low voltage electrical system that provides electrical power to a plurality of electricity consuming devices or systems.

2. The isolated mid-sized centralized photovoltaic solar station in accordance with claim 1, wherein the control unit is configured to output energy onto the low voltage electrical system such that the output voltage is less than 50 volts.

3. The isolated mid-sized centralized photovoltaic solar station in accordance with claim 1, wherein the plurality of batteries include at least one mobile battery that may be removed from the station to another location to use electrical energy stored by that mobile battery at that other location.

4. The isolated mid-sized centralized photovoltaic solar station in accordance with claim 3, wherein the battery subsystem includes locations at which one or more mobile batteries may be plugged into the battery subsystem to add to the plurality of batteries.

5. The isolated mid-sized centralized photovoltaic solar station in accordance with claim 1, wherein the battery subsystem includes locations at which one or more mobile batteries may be plugged into the battery subsystem to add to the plurality of batteries.

6. The isolated mid-sized centralized photovoltaic solar station in accordance with claim 1, further comprising:
a protection subsystem configured to protect the station from the low voltage electrical system.

7. The isolated mid-sized centralized photovoltaic solar station in accordance with claim 6, wherein the control unit and the protection subsystem are combined into a single unit.

8. A method for using an isolated mid-sized centralized photovoltaic solar station comprising:
an act of using a solar panel subsystem comprising one or more solar panel elements to directly convert photon energy into electricity;
an act of a control unit determining whether to store the electrical energy generated by the solar panel subsystem in a battery subsystem or provide the energy generated by the solar panel subsystem onto a low voltage electrical system that provides electrical power to a plurality of electricity consuming devices or systems; and
an act of the control unit further regulating electrical energy provided to the lower voltage electrical system.

9. The method in accordance with claim 8, wherein the control unit is configured to output energy onto the low voltage electrical system such that the output voltage is less than 50 volts.

10. The method in accordance with claim 8, wherein the battery subsystem comprises a plurality of batteries that are configured as an energy reservoir to store electrical energy generated by the solar panel subsystem such that the electrical energy may be used as needed regardless of whether sunlight is then present, wherein the plurality of batteries include at least one mobile battery that may be removed from the station to another location to use electrical energy stored by that mobile battery at that other location.

11. The method in accordance with claim 10, wherein the battery subsystem includes locations at which one or more mobile batteries may be plugged into the battery subsystem to add to the plurality of batteries.

12. The method in accordance with claim 9, further comprising:
an act of a protection subsystem configured to protect the station from the low voltage electrical system.

13. A method for using an isolated centralized mid-sized photovoltaic solar station comprising:
an act of using a solar panel subsystem comprising one or more solar panel elements to directly convert photon energy into electricity;
an act of a control unit determining whether to store the electrical energy generated by the solar panel subsystem in a battery subsystem or provide the energy generated by the solar panel subsystem onto an electrical system that provides electrical power to a plurality of electricity consuming devices or systems, wherein the battery subsystem comprises a plurality of batteries that are configured as an energy reservoir to store electrical energy generated by the solar panel subsystem such that the electrical energy may be used as needed regardless of whether sunlight is then present, wherein the plurality of batteries include at least one mobile battery;
an act of the control unit further regulating electrical energy provided to the electrical system; and
an act of removing the mobile battery from the station to another location to use electrical energy stored by that mobile battery at that other location.

14. The method in accordance with claim 13, wherein the control unit is configured to output energy onto the low voltage electrical system such that the output voltage is less than 50 volts.

15. The method in accordance with claim 13, further comprising returning the mobile battery to the station for recharging after the mobile battery has been used external to the station.

16. The isolated mid-sized centralized photovoltaic solar station in accordance with claim 1, wherein the station is capable of generating a power level that is greater than 5 kilowatts.

17. The isolated mid-sized centralized photovoltaic solar station in accordance with claim 16, wherein the power level is less than 500 kilowatts.

18. The isolated mid-sized centralized photovoltaic solar station in accordance with claim 1, the station being coupled to a local power grid.

19. The isolated mid-sized centralized photovoltaic solar station in accordance with claim 1, the station being permanently coupled to a local power grid.
